(19) United States
(12) Patent Application Publication
(10) Pub. No.: US 2022/0144314 A1
(43) Pub. Date: May 12, 2022

(54) CONTROL DEVICE, UNMANNED AERIAL VEHICLE, AND METHOD

(71) Applicant: Toyota Jidosha Kabushiki Kaisha, Toyota-shi Aichi-ken (JP)

(72) Inventors: Kazuya Nishimura, Anjo-shi (JP); Shin Sakurada, Toyota-shi (JP); Soutaro Kaneko, Nagoya-shi (JP)

(73) Assignee: Toyota Jidosha Kabushiki Kaisha, Toyota-shi Aichi-ken (JP)

(21) Appl. No.: 17/399,242

(22) Filed: Aug. 11, 2021

(30) Foreign Application Priority Data
Nov. 11, 2020 (JP) 2020-188060

(51) Int. Cl. B60W 60/00; G08G 5/00; B60W 50/14; B60W 40/13; G06Q 10/00

(52) U.S. Cl. CPC B60W 60/00256; G08G 5/0039; G08G 5/0021; B60W 50/14; B60W 2050/146; G06Q 10/30; B60W 2530/10; B60W 2050/143; B60W 40/13

(57) ABSTRACT

A control device includes a control unit. In the control device, the control unit acquires information indicating a flight path of an unmanned aerial vehicle that transports a cargo collected at a first point to a second point, determines whether the flight path has a third point where a person may be present on the ground, when it is determined that the flight path has the third point, sets an upper limit value of load capacity of the unmanned aerial vehicle, and when weight of the cargo is equal to or lower than the upper limit value, causes the unmanned aerial vehicle to collect and transport the cargo.

### CROSS-REFERENCE TO RELATED APPLICATION

This application claims priority to Japanese Patent Application No. 2020-188060 filed on Nov. 11, 2020, incorporated herein by reference in its entirety.

### BACKGROUND

### 1. Technical Field

The present disclosure relates to a control device, an unmanned aerial vehicle, and a method.

### 2. Description of Related Art

As a related art, a technique for transporting cargos using an unmanned aerial vehicle such as a drone has been known. For example, Japanese Unexamined Patent Application Publication No. 2018-203056 discloses that a drone collects and delivers a cargo stored in a storage device together with a load carrier.

### SUMMARY

Unfortunately, for example, if a cargo being transported falls from an unmanned aerial vehicle, the fallen cargo may hit people. Therefore, it is desired to improve the safety of cargo transportation using an unmanned aerial vehicle.

An object of the present disclosure is to improve the safety of cargo transportation using an unmanned aerial vehicle.

A control device according to an embodiment of the present disclosure is a control device including a control unit. The control unit acquires information indicating a flight path of an unmanned aerial vehicle that transports a cargo collected at a first point to a second point. The control unit determines whether the flight path has a third point where a person is likely to be present on the ground. When the control unit determines that the flight path has the third point, the control unit sets an upper limit value of load capacity of the unmanned aerial vehicle. When weight of the cargo is equal to or lower than the upper limit value, the control unit causes the unmanned aerial vehicle to collect and transport the cargo.

An unmanned aerial vehicle according to an embodiment of the present disclosure is an unmanned aerial vehicle including a control unit. The control unit acquires information indicating a flight path of the unmanned aerial vehicle that transports a cargo collected at a first point to a second point. The control unit determines whether the flight path has a third point where a person is likely to be present on the ground. When the control unit determines that the flight path has the third point, the control unit sets an upper limit value of load capacity of the unmanned aerial vehicle. When weight of the cargo is equal to or lower than the upper limit value, the control unit causes the unmanned aerial vehicle to collect and transport the cargo.

A method according to an embodiment of the present disclosure is a method executed by a control device. The method includes: acquiring information indicating a flight path of an unmanned aerial vehicle that transports a cargo collected at a first point to a second point; determining whether the flight path has a third point where a person is likely to be present on the ground; setting an upper limit value of load capacity of the unmanned aerial vehicle when the control device determines that the flight path has the third point; and causing the unmanned aerial vehicle to collect and transport the cargo when weight of the cargo is equal to or lower than the upper limit value.

According to an embodiment of the present disclosure, safety of cargo transportation using an unmanned aerial vehicle is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to an embodiment of the present disclosure;

FIG. 2 is a block diagram showing a schematic configuration of an unmanned aerial vehicle;

FIG. 3 is a block diagram showing a schematic configuration of a control device; and

FIG. 4 is a flowchart showing operation of the control device.

### DETAILED DESCRIPTION OF EMBODIMENTS

Hereinafter, an embodiment of the present disclosure will be described.

### Outline of Embodiment

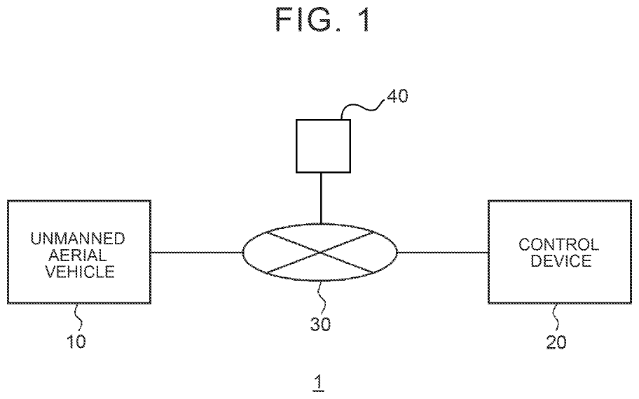

The outline of a system 1 according to the embodiment of the present disclosure will be described with reference to FIG. 1. The system 1 includes an unmanned aerial vehicle 10 and a control device 20.

The control device 20 is an information processing device such as a computer. The control device 20 can communicate with the unmanned aerial vehicle 10 via a network 30 such as the Internet and a mobile communication network.

The unmanned aerial vehicle 10 is any aerial vehicle that no one is onboard. For example, an aerial vehicle such as a drone and a multicopter can be adopted as the unmanned aerial vehicle 10. The unmanned aerial vehicle 10 can fly autonomously or by cooperating with the control device 20. For example, the unmanned aerial vehicle 10 may be movable along a flight path acquired from the control device 20. The unmanned aerial vehicle 10 may also be able to autonomously bypass an obstacle when the obstacle is detected by using a camera. In the present embodiment, the unmanned aerial vehicle 10 is used for logistics services for cargo transportation.

First, the outline of the present embodiment will be described, and the details will be described later. In the present embodiment, the control device 20 acquires information indicating a flight path of the unmanned aerial vehicle 10 that transports a cargo collected at a first point to a second point. The control device 20 determines whether the flight path has a third point where people may be present on the ground. When the control device 20 determines that the flight path has the third point, the control device 20 sets an upper limit value of the load capacity of the unmanned aerial vehicle 10. When the weight of the cargo is equal to or less than the upper limit value, the control device 20 causes the unmanned aerial vehicle 10 to collect and transport the cargo.

As described above, according to the present embodiment, in a case where the unmanned aerial vehicle 10 passes over the third point where people may be present on the ground, an upper limit value is set for the weight of a cargo to be transported by the unmanned aerial vehicle 10. Therefore, in the unlikely event that the cargo accidentally falling from the unmanned aerial vehicle 10 hits a person on the ground, the configuration reduces the possibility that he or she hit by the cargo may be injured as compared with a configuration in which the upper limit value is not set for the weight of the cargo. Therefore, the safety of cargo transportation using the unmanned aerial vehicle 10 is improved.

Next, configurations in the system 1 will be described in detail.

### Configuration of Unmanned Aerial Vehicle

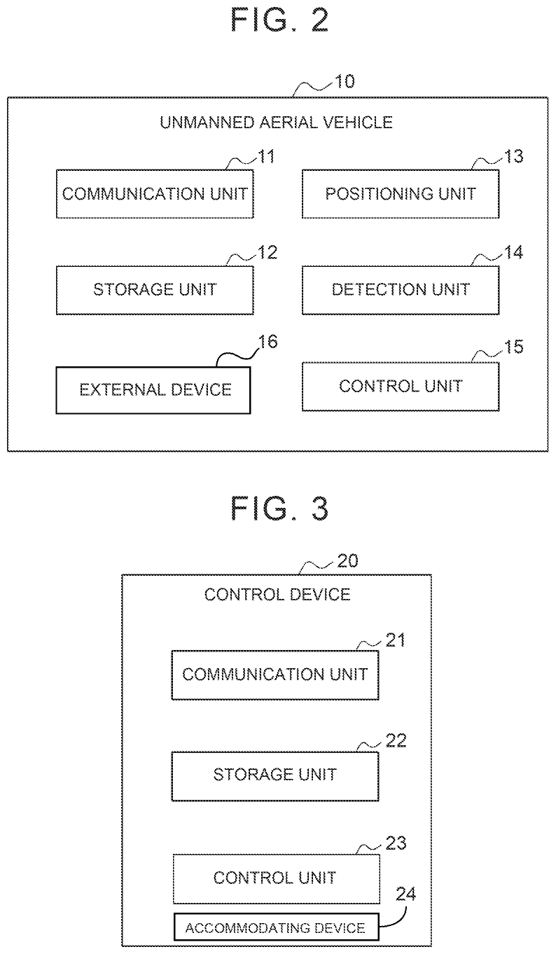

As shown in FIG. 2, the unmanned aerial vehicle 10 includes a communication unit 11, a storage unit 12, a positioning unit 13, a detection unit 14, a control unit 15, and an external device 16.

The communication unit 11 includes one or more communication interfaces connected to the network 30. The communication interface supports, for example, 4th generation (4G) and 5th generation (5G) mobile communication standards. The supported standards are not limited to these, and the communication interface may support any mobile communication standards. In this embodiment, the unmanned aerial vehicle 10 communicates with the control device 20 via the communication unit 11.

The storage unit 12 includes one or more memories. The memories are, for example, a semiconductor memory, a magnetic memory, or an optical memory, but are not limited to these memories. Each memory included in the storage unit 12 may function as, for example, a main storage device, an auxiliary storage device, or a cache memory. The storage unit 12 stores any information used for the operation of the unmanned aerial vehicle 10. For example, the storage unit 12 may store a system program, an application program, and embedded software. The information stored in the storage unit 12 may be updatable with information received from the network 30 via the communication unit 11, for example.

The positioning unit 13 includes a receiver compatible with a satellite positioning system. The receiver is compatible with, for example, the Global Positioning System (GPS), but the compatible satellite positioning system is not limited to this, and the receiver may be compatible with any satellite positioning system. The positioning unit 13 also includes, for example, a gyro sensor, a geomagnetic sensor, and a barometric pressure sensor. In the present embodiment, the unmanned aerial vehicle 10 can acquire its position information, the direction in which the unmanned aerial vehicle 10 is facing, and its inclination by using the positioning unit 13. The position information may include two-dimensional coordinate data including latitude and longitude, and may include three-dimensional coordinate data including altitude in addition to latitude and longitude.

The detection unit 14 includes one or more sensors used for detecting obstacles existing around the unmanned aerial vehicle 10. In the present embodiment, the sensors include, but are not limited to, a camera, and may include, for example, a millimeter wave radar or light detection and ranging (LiDAR). The output information of the sensors of the detection unit 14 can be used, for example, for the unmanned aerial vehicle 10 to fly while autonomously bypassing obstacles around the unmanned aerial vehicle 10.

The control unit 15 includes one or more processors, one or more programmable circuits, one or more dedicated circuits, or a combination of these. The processors are, for example, a general-purpose processor such as a central processing unit (CPU) or a graphics processing unit (GPU), or a dedicated processor specialized for a specific process, but are not limited to these processors. The programmable circuits are, for example, a field-programmable gate array (FPGA), but are not limited to the circuit. The dedicated circuits are, for example, an application specific integrated circuit (ASIC), but are not limited to the circuit. The control unit 15 controls the operation of the entire unmanned aerial vehicle 10.

### Configuration of Control Device

As shown in FIG. 3, the control device 20 includes a communication unit 21, a storage unit 22, a control unit 23, and an accommodating device 24.

The communication unit 21 includes one or more communication interfaces connected to the network 30. The communication interfaces support, for example, a mobile communication standard, a wired local area network (LAN) standard, or a wireless LAN standard, but the supported standards are not limited to these, and the communication interfaces may support any communication standard. In this embodiment, the unmanned aerial vehicle 10 communicates with the control device 20 via the communication unit 21.

The storage unit 22 includes one or more memories. Each memory included in the storage unit 22 may function as, for example, a main storage device, an auxiliary storage device, or a cache memory. The storage unit 22 stores any information used for the operation of the control device 20. For example, the storage unit 22 may store a system program, an application program, a database, and map information. The map information may include a schematic diagram showing roads, facilities, and the like located on the ground, or may include satellite photographs. The information stored in the storage unit 22 may be updatable with information received from the network 30 via the communication unit 21, for example.

The control unit 23 includes one or more processors, one or more programmable circuits, one or more dedicated circuits, or a combination of these. The control unit 23 controls the operation of the entire control device 20. Details of the operation of the control device 20 controlled by the control unit 23 will be described later. The accommodating device 24 is configured to measure a weight of contents of the cargo collected and transported by the unmanned aerial vehicle 10. The cargo may include waste such as garbage put into the accommodating device 24.

### Operation Flow of Control Device

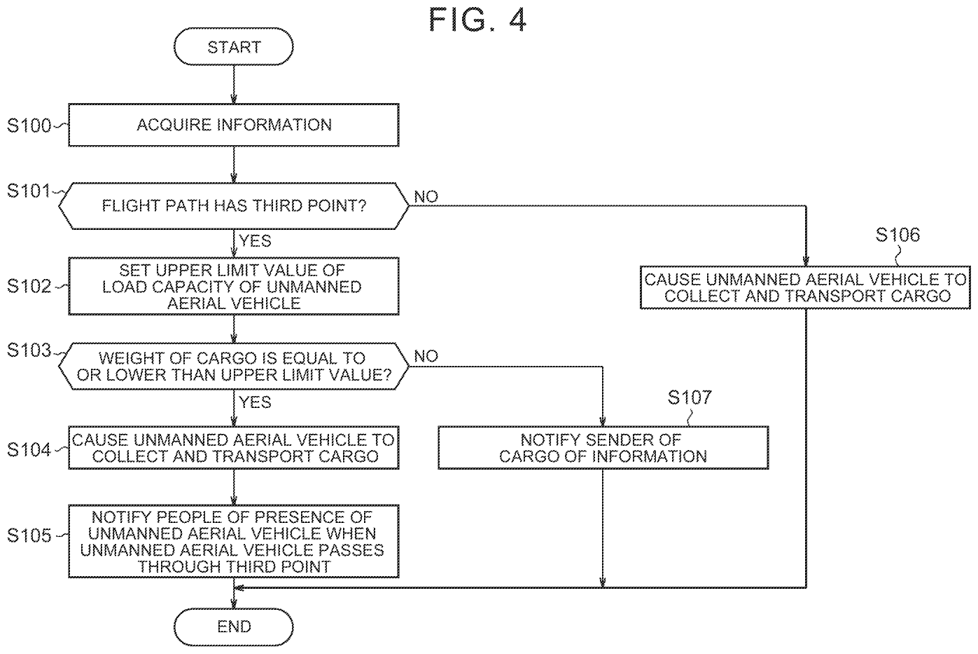

The operation of the control device 20 according to the present embodiment will be described with reference to FIG. 4.

In step S100, the control unit 23 of the control device 20 acquires information related to a cargo to be transported by the unmanned aerial vehicle 10.

The information related to the cargo includes, for example, information indicating the weight of the cargo, information indicating the flight path of the unmanned aerial vehicle 10 for transporting the cargo collected at the first point to the second point. The information related to the cargo is not limited to these, and may include any information related to the cargo. The information indicating the flight path may include, for example, information of the path along which the unmanned aerial vehicle 10 should fly and information of the scheduled arrival time at which the unmanned aerial vehicle 10 will arrive at a point included in the path. Any method can be adopted to acquire information related to the cargo. In one example, the control unit 23 may acquire information related to a cargo by receiving information indicating the weight of the cargo, information indicating the first and second points, and information indicating the scheduled collection time at which the cargo will be collected at the first point from an information processing device such as a smartphone or a computer used by the sender of the cargo via the network 30 and the communication unit 21. The control unit 23 may acquire information related to the cargo by generating information indicating the flight path of the unmanned aerial vehicle 10 that transports the cargo collected at the first point to the second point based on the map information stored in the storage unit 22, the position information of the first point and the second point, and the scheduled collection time for the cargo. However, the acquisition of information related to the cargo is not limited to this example.

In step S101, the control unit 23 determines whether the flight path acquired in step S100 has the third point. When the control unit 23 determines that the flight path has the third point (step S101—Yes), the process proceeds to step S102. In contrast, when the control unit 23 determines that the flight path does not have the third point (step S101—No), the process proceeds to step S106.

The third point is a point where people may be present on the ground. Any method can be adopted to determine whether people may be present on the ground at a certain point. In one example, the control unit 23 may refer to the map information stored in the storage unit 22, and determine that people may be present on the ground at predetermined points such as a sidewalk, a park, and a sandy beach, and determine that it is unlikely that people are present at the other points. In other words, the control unit 23 may identify a predetermined point that is specified based on the map information as the third point. Alternatively, the control unit 23 may acquire information indicating a past measured value or predicted value of the traffic volume or density of people for each point and each time zone via the communication unit 21 and the network 30. In such a case, the control unit 23 refers to the scheduled arrival time at which the unmanned aerial vehicle 10 will arrive at a point on the flight path. When the traffic volume or density of people at the point at the scheduled arrival time is equal to or higher than a predetermined reference value, the control unit 23 determines that people may be present on the ground at the point. When the traffic volume or density of people is less than the reference value, the control unit 23 determines that it is unlikely that people are present on the ground at the point.

Here, the third point may be a point where people may be present, among points where there is no shield between the ground and the sky. Any method can be adopted to determine whether there is a shield between the ground and the sky at a certain point. In one example, the control unit 23 may determine, using a satellite photograph included in the map information stored in the storage unit 22, that there is a shield between the ground and the sky at a certain point when a predetermined shield such as a roof is detected at the point by image recognition, and that there is no shield between the ground and the sky at the point when the predetermined shield is not detected.

In step S102, when the control unit 23 determines that the flight path has the third point in step S101 (step S101—Yes), the control unit 23 sets the upper limit value of the load capacity of the unmanned aerial vehicle 10.

Any value that is in the range less than the rated load capacity of the unmanned aerial vehicle 10 can be set as the upper limit value of the load capacity of the unmanned aerial vehicle 10. In one example, the control unit 23 may decrease the upper limit value of the load capacity as the traffic volume of people is larger or the density of people is higher at the third point at the scheduled arrival time. The control unit 23 may also decrease the upper limit value of the load capacity as the date of manufacturing of the unmanned aerial vehicle 10 is older, the last maintenance date for the unmanned aerial vehicle 10 is older, or the operating hours of the unmanned aerial vehicle 10 is longer. The control unit 23 may also set the upper limit value of the load capacity based on how the unmanned aerial vehicle 10 holds a cargo. For example, when a cargo is accommodated in an accommodating space provided integrally with the unmanned aerial vehicle 10, the upper limit value of the load capacity may be decreased as compared with a case where the cargo is suspended through a member such as a hook provided in the unmanned aerial vehicle 10.

In step S103, the control unit 23 determines whether the weight of the cargo to be transported is equal to or less than the upper limit value of the load capacity set in step S102. When the control unit 23 determines that the weight of the cargo is equal to or less than the upper limit value (step S103—Yes), the process proceeds to step S104. In contrast, when the control unit 23 determines that the weight of the cargo exceeds the upper limit value (step S103—No), the process proceeds to step S107.

In step S104, when the control unit 23 determines that the weight of the cargo is equal to or less than the upper limit value in step S103 (step S103—Yes), the control unit 23 causes the unmanned aerial vehicle 10 to collect and transport the cargo.

Specifically, the control unit 23 notifies the unmanned aerial vehicle 10 of the flight path from the first point to the second point acquired in step S100, via the communication unit 21 and the network 30. When the unmanned aerial vehicle 10 is notified of the flight path by the control device 20, the control unit 15 of the unmanned aerial vehicle 10 causes the unmanned aerial vehicle 10 to move toward the first point. The unmanned aerial vehicle 10 collects the cargo at the first point, and then the control unit 15 causes the unmanned aerial vehicle 10 to start moving toward the second point along the flight path. In collecting the cargo by the unmanned aerial vehicle 10, for example, the sender may attach the cargo to the unmanned aerial vehicle 10 at the first point, or the unmanned aerial vehicle 10 may automatically collect the cargo placed at the first point.

In step S105, the control unit 23 of the control device 20 notifies people at the third point of the presence of the unmanned aerial vehicle 10 when the unmanned aerial vehicle 10 passes through the third point during the cargo transportation.

Specifically, the control unit 23 communicates with the unmanned aerial vehicle 10 via the communication unit 21 and the network 30 while the unmanned aerial vehicle 10 is moving from the first point to the second point, thereby monitoring the position information of the unmanned aerial vehicle 10. When the distance along the flight path between the unmanned aerial vehicle 10 and the third point becomes less than a predetermined value, the control unit 23 notifies people at the third point of the presence of the unmanned aerial vehicle 10.

Here, any method can be adopted for notifying people at the third point of the presence of the unmanned aerial vehicle 10. In one example, the control unit 23 may communicate with the external device 16 described later via the communication unit 21 and the network 30. The control unit 23 may notify people at the third point of the presence of the unmanned aerial vehicle 10 via the external device 16. Here, the external device 16 is, but is not limited to, a light source device, a display or a speaker provided at the third point, or a terminal device 40 carried by people at the third point. Specifically, the control unit 23 can notify people at the third point of the presence of the unmanned aerial vehicle 10 by causing the light source device provided at the third point to emit light, or outputting information indicating that the unmanned aerial vehicle 10 will pass over the third point via a display or a speaker provided at the third point or terminal devices 40 of people at the third point.

Alternatively, the control unit 23 may notify the people of the presence of the unmanned aerial vehicle 10 via a light source device or a speaker provided in the unmanned aerial vehicle 10. Specifically, the control unit 23 can notify people at the third point of the presence of the unmanned aerial vehicle 10 by causing a light source device of the unmanned aerial vehicle 10 to emit light to shine light on the ground, or outputting information indicating that the unmanned aerial vehicle 10 passes over the third point via a speaker of the unmanned aerial vehicle 10.

In step S106, when the control unit 23 determines that the flight path does not have the third point in step S101 (step S101—No), the control unit 23 causes the unmanned aerial vehicle 10 to collect and transport the cargo.

In step S107, when the control unit determines that the weight of the cargo exceeds the upper limit value in step S103 (step S103—No), the control unit 23 notifies the sender of the cargo of information. The information of which the sender is notified may include, for example, information prompting the sender to use a transportation mode other than the unmanned aerial vehicle 10, information prompting the sender to change the scheduled collection time for the cargo, or information prompting the sender to reduce the weight of the cargo, but is not limited to such information.

As described above, in the present embodiment, the control device 20 according to the embodiment acquires information indicating the flight path of the unmanned aerial vehicle 10 that transports the cargo collected at the first point to the second point. The control device 20 determines whether the flight path has the third point where people may be present on the ground. When the control device 20 determines that the flight path has the third point, the control device 20 sets the upper limit value of the load capacity of the unmanned aerial vehicle 10. When the weight of the cargo is equal to or less than the upper limit value, the control device 20 causes the unmanned aerial vehicle 10 to collect and transport the cargo.

According to the configuration, in a case where the unmanned aerial vehicle 10 passes over the third point where people may be present on the ground, the upper limit value is set for the weight of the cargo to be transported by the unmanned aerial vehicle 10. Therefore, in the unlikely event that the cargo accidentally falling from the unmanned aerial vehicle 10 hits a person on the ground, the configuration reduces the possibility that he or she hit by the cargo may be injured as compared with a configuration in which the upper limit value is not set for the weight of the cargo. Therefore, the safety of cargo transportation using the unmanned aerial vehicle 10 is improved.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above embodiment, the configuration and operation of the control device 20 may be distributed to a plurality of information processing devices capable of communicating with each other. Furthermore, for example, an embodiment in which a part of or all of the components of the control device 20 are provided in the unmanned aerial vehicle 10 is also possible.

Moreover, in the above-described embodiment, the cargo collected and transported by the unmanned aerial vehicle 10 may include waste such as garbage put into the accommodating device 24 capable of measuring the weight of the contents. In such a case, the system 1 can be used, for example, to provide a waste collection service. In one example, the control unit 23 of the control device 20 monitors the weight of the waste put into the accommodating device 24 by communicating with the accommodating device 24 via the communication unit 21 and the network 30. The control unit 23 calculates and obtains a predicted weight of the waste at the scheduled collection time based on changes in the weight of the waste. When the predicted weight of the waste at the scheduled collection time exceeds the upper limit value of the load capacity of the unmanned aerial vehicle 10, the control unit 23 advances the scheduled collection time. According to the configuration, when the flight path of the unmanned aerial vehicle 10 has the third point where people may be present on the ground, the probability that the unmanned aerial vehicle 10 can collect the waste before the weight of the waste to be collected exceeds the load capacity of the unmanned aerial vehicle 10 is increased.

An embodiment is also possible in which, for example, a general-purpose drone or a computer functions as the unmanned aerial vehicle 10 or the control device 20 according to the above-described embodiment. Specifically, a program describing processing contents for realizing each function of the unmanned aerial vehicle 10 or the control device 20 according to the above-described embodiment is stored in the memory of a general-purpose drone or a computer, and the program is read out and executed by the processor. Therefore, the disclosure according to the present embodiment can also be realized as a program that can be executed by a processor or a non-transitory computer-readable medium that stores the program.

What is claimed is:

1. A control device comprising a control unit, wherein:
the control unit acquires information indicating a flight path of an unmanned aerial vehicle that transports a cargo collected at a first point to a second point;
the control unit determines whether the flight path has a third point where a person is likely to be present on the ground;
when the control unit determines that the flight path has the third point, the control unit sets an upper limit value of load capacity of the unmanned aerial vehicle; and
when weight of the cargo is equal to or lower than the upper limit value, the control unit causes the unmanned aerial vehicle to collect and transport the cargo.

2. The control device according to claim 1, wherein the control unit decreases the upper limit value as traffic volume of people is larger or density of people is higher at the third point.

3. The control device according to claim 1, wherein when the weight of the cargo exceeds the upper limit value, the control unit notifies a sender of the cargo of information prompting the sender to use a transportation mode other than the unmanned aerial vehicle, information prompting the sender to change a scheduled collection time for the cargo, or information prompting the sender to reduce the weight of the cargo.

4. The control device according to claim 1, wherein:
the cargo includes waste put into an accommodating device that is able to measure weight of a content; and
when a predicted weight of the waste at a scheduled collection time exceeds the upper limit value, the control unit advances the scheduled collection time.

5. The control device according to claim 1, wherein when the unmanned aerial vehicle passes through the third point during transportation of the cargo, the control unit notifies the person at the third point of presence of the unmanned aerial vehicle.

6. The control device according to claim 5 further comprising a communication unit that communicates with an external device, wherein:
the control unit notifies the person at the third point of the presence of the unmanned aerial vehicle via the external device; and
the external device includes: a light source device, a display, or a speaker provided at the third point; or a terminal device carried by the person at the third point.

7. The control device according to claim 5, wherein the control unit notifies the person at the third point of the presence of the unmanned aerial vehicle via a light source device or a speaker provided in the unmanned aerial vehicle.

8. An unmanned aerial vehicle comprising a control unit, wherein:
the control unit acquires information indicating a flight path of the unmanned aerial vehicle that transports a cargo collected at a first point to a second point;
the control unit determines whether the flight path has a third point where a person is likely to be present on the ground;
when the control unit determines that the flight path has the third point, the control unit sets an upper limit value of load capacity of the unmanned aerial vehicle; and
when weight of the cargo is equal to or lower than the upper limit value, the control unit causes the unmanned aerial vehicle to collect and transport the cargo.

9. The unmanned aerial vehicle according to claim 8, wherein the control unit decreases the upper limit value as traffic volume of people is larger or density of people is higher at the third point.

10. The unmanned aerial vehicle according to claim 8, wherein when the weight of the cargo exceeds the upper limit value, the control unit notifies a sender of the cargo of information prompting the sender to use a transportation mode other than the unmanned aerial vehicle, information prompting the sender to change a scheduled collection time for the cargo, or information prompting the sender to reduce the weight of the cargo.

11. The unmanned aerial vehicle according to claim 8, wherein:
the cargo includes waste put into an accommodating device that is able to measure weight of a content; and
when a predicted weight of the waste at a scheduled collection time exceeds the upper limit value, the control unit advances the scheduled collection time.

12. The unmanned aerial vehicle according to claim 8, wherein when the unmanned aerial vehicle passes through the third point during transportation of the cargo, the control unit notifies the person at the third point of presence of the unmanned aerial vehicle.

13. The unmanned aerial vehicle according to claim 12 further comprising a light source device or a speaker, wherein the control unit notifies the person at the third point of the presence of the unmanned aerial vehicle via the light source device or the speaker.

14. A method executed by a control device, the method comprising:
acquiring information indicating a flight path of an unmanned aerial vehicle that transports a cargo collected at a first point to a second point;
determining whether the flight path has a third point where a person is likely to be present on the ground;
setting an upper limit value of load capacity of the unmanned aerial vehicle when the control device determines that the flight path has the third point; and
causing the unmanned aerial vehicle to collect and transport the cargo when weight of the cargo is equal to or lower than the upper limit value.

15. The method according to claim 14, wherein the upper limit is set so as to decrease as traffic volume of people is larger or density of people is higher at the third point.

16. The method according to claim 14 further comprising notifying a sender of the cargo of information prompting the sender to use a transportation mode other than the unmanned aerial vehicle, information prompting the sender to change a scheduled collection time for the cargo, or information prompting the sender to reduce the weight of the cargo, when the weight of the cargo exceeds the upper limit value.

17. The method according to claim 14, wherein:
the cargo includes waste put into an accommodating device that is able to measure weight of a content; and
the method further includes advancing the scheduled collection time when a predicted weight of the waste at a scheduled collection time exceeds the upper limit value.

18. The method according to claim 14, further comprising notifying the person at the third point of presence of the unmanned aerial vehicle when the unmanned aerial vehicle passes through the third point during transportation of the cargo.

19. The method according to claim 18, wherein:
the control device further includes a communication unit that communicates with an external device;
the person at the third point is notified of the presence of the unmanned aerial vehicle via the external device; and
the external device includes: a light source device, a display, or a speaker provided at the third point; or a terminal device carried by the person at the third point.

20. The method according to claim 18, wherein the person at the third point is notified of the presence of the unmanned aerial vehicle via a light source device or a speaker provided in the unmanned aerial vehicle.
